(19) United States
(12) Patent Application Publication
(10) Pub. No.: US 2010/0040060 A1
(43) Pub. Date: Feb. 18, 2010

(54) FAST EMULATION OF MAC TABLE FLUSHING FOR ELAN UNICASTS

(75) Inventor: Maurice Gleeson, Barna (IE)

Correspondence Address: BRAKE HUGHES BELLERMANN LLP;c/o CPA Global, P.O. Box 52050, Minneapolis, MN, 55402, US

(73) Assignee: Broadcom Corporation, Irvine, CA (US)

(21) Appl. No.: 12/501,071

(22) Filed: Jul. 10, 2009

(30) Foreign Application Priority Data
Jul. 12, 2008 (GB) 08 12804.3

(51) Int. Cl. H04L 12/56

(52) U.S. Cl. 370/392; 370/395.53

(57) ABSTRACT

According to one general aspect, an apparatus may include a plurality of ports, a port forwarding processor, and a queue controller. In some embodiments, the plurality of ports may be configured to receive and forward packets within a communications network. In various embodiments, the port forwarding processor may be configured to determine a destination port associated with a received packet. In one embodiment, the queue controller may be configured to define at least one emulated local area network (ELAN) via a respective service member set that identifies which ports are members of the service member set, determine whether or not the destination port is a permitted member of the service member set, and, if the destination port associated with the received packet is not a permitted member of the service member set, flood the received packet to the permitted members of the service member set.

### CROSS-REFERENCE TO RELATED APPLICATION

This application claims priority under 35 U.S.C. §119 to British Patent Application GB 0812804.3, filed Jul. 12, 2008, titled “FAST EMULATION OF MAC TABLE FLUSHING FOR ELAN UNICASTS,” which is incorporated herein by reference in its entirety.

### TECHNICAL FIELD

This disclosed subject matter relates to packet-switched networks and in particular to the management of MAC (Media Access Control) tables in switches or other network devices that provide Emulated Local Area Network (ELAN) service.

### BACKGROUND

When an addressed packet is received by a network device such as a switch one of many operations that are performed is a MAC table lookup to determine the port or ports to which the packet or instances of the packet should be sent for forwarding to the external network.

It is customary to provide ageing of MAC tables. In practice this is performed by software removal of an entry at a given time after the entry is established unless the entry is refreshed. Generally, in normal practice, if MAC addresses which have been learnt for a particular port are not refreshed, all the addresses gradually age out. This is potentially inefficient.

### SUMMARY

According to one general aspect, an apparatus may include a plurality of ports, a port forwarding processor, and a queue controller. In some embodiments, the plurality of ports may be configured to receive and forward packets within a communications network. In various embodiments, the port forwarding processor may be configured to determine a destination port associated with a received packet. In one embodiment, the queue controller may be configured to define at least one emulated local area network (ELAN) via a respective service member set that identifies which ports are members of the service member set, determine whether or not the destination port is a permitted member of the service member set, and, if the destination port associated with the received packet is not a permitted member of the service member set, flood the received packet to the permitted members of the service member set.

According to another general aspect, a method of transmitting data via a networking apparatus may include receiving and transmitting, via a plurality of ports, packets within a communications network. In some embodiments, the method may also include determining a destination port associated with a received packet. In one embodiment, the method may include defining at least one emulated local area network (ELAN) via a respective service member set that identifies which ports are members of the service member set. In various embodiments, the method may include determining whether or not the destination port is a permitted member of the service member set. In some embodiments, the method may include, if the destination port associated with the received packet is not a permitted member of the service member set, flooding the received packet to the permitted members of the service member set.

According to another general aspect, a computer program product for transmitting information, may include executable code that, when executed, is configured to cause a networking apparatus to receive and transmit, via a plurality of ports, packets within a communications network. In some embodiments, the code may be configured to cause the apparatus to determine a destination port associated with a received packet. In some embodiments, the code may be configured to cause the apparatus to define at least one emulated local area network (ELAN) via a respective service member set that identifies which ports are members of the service member set. In some embodiments, the code may be configured to cause the apparatus to determine whether or not the destination port is a permitted member of the service member set. In some embodiments, the code may be configured to cause the apparatus to, if the destination port associated with the received packet is not a permitted member of the service member set, flood the received packet to the permitted members of the service member set. In various embodiments, the computer program product being tangibly embodied on a computer-readable medium.

According to another general aspect, a switch for use in a packet-switched communication network may include a multiplicity of ports for the reception of packets from the network and for the forwarding of packets to the network. In various embodiments, the switch may be configured to define at least one emulated local area network by means of a respective service member set that identifies which ports are members of the set. In one embodiment, the switch may be configured to, in response to a MAC address lookup which identifies for a received packet a known unicast destination port, to determine whether that port is a permitted member of the said set. In some embodiments, the switch may be configured to in the event that said port is not a permitted member of the said set, to flood the packet to all the permitted members of the set.

According to another general aspect, a method of operating a switch in a packet-switched communication network, the switch including a multiplicity of ports for the reception of packets from the network and for the forwarding of packets to the network, may include defining at least one emulated local area network by means of a respective service member set that identifies which ports are members of the set. In some embodiments, the method may include transferring in respect of said set connectivity of destinations associated with a given port to at least another port whereby said given port ceases to be a permitted member of the set. In various embodiments, the method may include in response to a MAC address lookup which identifies for a received packet a known unicast destination port corresponding to said given port, flooding the packet to all the permitted members of the set.

According to the disclosed subject matter a switch which provides ELAN emulation may include the specification of ports in a service member set configured to remove a particular selected port from the service member set, transfer connectivity of destinations previously associated with that port to another port, and, in response to a lookup which yields an ELAN unicast which identifies the particular port, to flood the packet to all the other permitted members of the service member set. In various embodiments, the aforementioned transfer may occur either by imposing a reconfiguration of the service member set or may occur by the operation of a spanning tree protocol. In either event, a response to the flooding from the specified destination may cause a learning event to update a MAC table for the port from which that response is received.

The details of one or more implementations are set forth in the accompanying drawings and the description below. Other features will be apparent from the description and drawings, and from the claims.

A system and/or method for communicating information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIGS. 2A and 2B illustrate one circumstance in which the switch may provide fast emulation of MAC table aging in accordance with the disclosed subject matter.

FIG. 3 illustrates another circumstance in which the switch provides fast emulation of MAC table aging in accordance with the disclosed subject matter.

### DETAILED DESCRIPTION

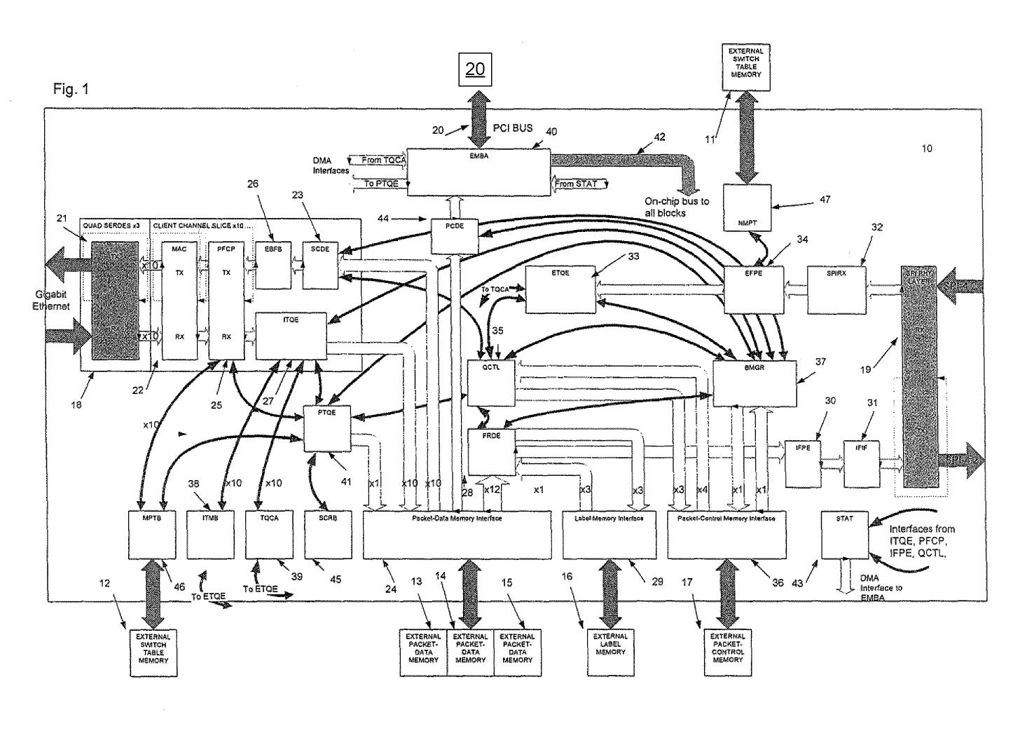

FIG. 1 illustrates schematically one network device, particularly a 20 Gb Ethernet switch in which the disclosed subject matter may be implemented. This is given by way of example only. It will be understood that such a switch has by virtue of its intended versatility may include functional features that are not directly relevant to the specific disclosed subject matter and therefore many of the parts of the device will be described only briefly. It is presumed that the reader is familiar with the familiar with the IEEE 802.1 standards and carrier Ethernet technology generally.

The switch 10 shown in FIG. 1 may switch and map traffic between the so-called “client” ports, each being Gigabit Ethernet, up to 128 network ports, each being a SPI-4.2 channel, and a control processor (CP) port which is a PCI 2.2 interface. Throughout the Figure, control paths between blocks are indicated by narrow solid lines and data paths (e.g., paths for packet data) are indicated by the wider arrows.

The switch 10 (apart from the external memories to which it has access) may be implemented on a single chip. The external memories, which will be mentioned in more detail later, may include two external switch table memories 11 and 12, three “packet” memories 13, 14 and 15, an external “label” memory 16, and an external “packet control” memory 17.

It is convenient to mention briefly here that the external switch table memories 11 and 12 may be used or employed in an address lookup processes. The three packet memories 13, 14 and 15 may be used or employed to store the payloads of packets while control entries derived (principally) from the headers of packets are processed. The external label memory 16 may be used or employed to store short data segments, for example those for insertion in the various packets of a multicast transmission, as described for example in co-pending GB patent application No. 0807881.5. The label memory may also include short data segments for insertion in unicast packets. The external packet control memory 17 may be used or employed to queue control entries before packets are reconstituted from control entries and payloads, as described for example in our co-pending European patent application No. 08250403.6 filed 4 Feb. 2008.

The client ports are denoted by the reference 18. The network ports are denoted by the reference 19 and the control processor port is denoted by the reference 20. Only the parts of a single client port 18 are shown. Each client port has integrated serializer/deserializers (SERDES) 21, so that each client port can receive and transmit at 1 Gb/s, a media access control (MAC) layer 22, and a physical coding sublayer (PCS), not shown,

For each client port, a single channel de-queuing Engine (SCDE) 23 reads frames from data memory, e.g., the memories 13-15, by way of a packet-data memory interface 24. The SCDE 23 passes the frame data, together with the relevant control-entry parameters required to perform transmit-port processing, to a port forwarding and classification processor (PFCP) 25. As each frame is de-queued for transmission to a client port, the frame is written to the egress burst frame buffer (EBFB) 26 for that client port. Multiple frames are written to the EBFB. The EBFB 26 compensates for packet-data memory latency and guarantees full-wire-speed transmission to the client port. The client channel logic does not transmit from the frame buffer until a full frame is available or until the EBFB 26 fills.

The EBFB 26 monitors the fill levels of the buffer to provide status to both the write side and read side, indicating when a burst of data from external packet-data memory can be written, and when a frame or multiple frames are available for onward transmission.

Frames received in client ports may be queued to external packet memory (13, 14, 15) by means of a respective ingress traffic queuing engine (ITOE) 27.

The particular nature of the control entries is not important to the present disclosed subject matter; a specific example is described later. More simply each comprises a field which denotes the size of the packet, and a field SP (service parameters), which refers to customary service parameters. These may include one or other of a unicast destination port, default flood map or multicast flood maps. Next is a memory pointer, which points to the location in data memory 13-15 where the packet is stored while the control entry is processed and from which it will be retrieved when the control entry has finally been de-queued. A Virtual Private LAN Service (VPLS) field includes flags for identifying the packet as a VPLS packet and a field which is used in conjunction with a replication database to determine the number of replications of a packet for a given port. Another field indicates directly or indirectly the port or ports from which one or more instances of the packet are to be forwarded. It will map to a port bit mask. Another field comprises various tags. A “multicast” field can map to an entry in a multicast table. A “single destination port” field indicates whether the packet is going to a single destination port or to multiple destinations. Another field indicates whether the packet is an “ELAN” packet, transmitted over an emulated LAN, or an “eline” packet, transmitted over an emulated point-to-point connection.

The network ports are represented by the SPI PHY layer 19. For transmission from any of the network ports, a frame reader engine (FRDE) 28, reads multiple frames from data memory 13-15 for multiple network ports. The FRDE 28 passes the frame data, together with the relevant control-entry parameters required to perform network-port encapsulation and transmit-port processing as well as labels from the memory 16 by way of the label memory interface 29, to an ingress frame processing engine (IFPE) 30. Frames for transmission are temporarily stored in an ingress FIFO (IFIF) 31. The FRDE can support up to 128 network ports concurrently.

For frames received by network ports (e.g., the SPI PHY layer), a SPIRX block 32 provides an interface between the SPI-4.2 protocol processing and the core logic. The primary functions of the SPIRX block may include the ability to provide an elasticity buffer, a per-port buffer and header assembly, and clock crossing. The elasticity buffer may be used or employed to manage disparity between the number of write and read cycles during the reception of continuation control words on the SPI interface. In this situation, data might be received for two different ports within the same clock tick. The data is written to the elasticity buffer in a single clock, but must be copied to the individual per-port buffers, and hence takes two cycles. The elasticity buffer also manages temporary “back pressure” from a FIFO in an egress traffic queuing engine (ETQE) 33.

The SPIRX block also is organized for the transfer of data from the elasticity buffer to a per-port buffer. The per-port buffer assembles frame headers on a per-port basis and may also frame store-and-forward buffering. Data transfer to the per-port buffer is preferably controlled by a round-robin arbiter. Frame headers can be up to 128 bytes, to facilitate frame-header parsing by an egress frame processing engine (EFPE) 34, which parses frames before they are passed to the egress traffic queuing engine (ETQE) 33.

An important component of the disclosed subject matter is a queue controller (QCTL) 35, which has various functions, which will be described in more detail in relation to the disclosed subject matter claimed herein. The queue controller writes control entries into and reads control entries from the external packet control memory 17 by way of a packet-control memory interface 36, in a manner described in our co-pending GB patent application No. 0806014.7.

However, by way of preliminary and for the sake of completeness, the features of the rest of the switch will be described.

A buffer manager (BMGR) 37 is coupled to the interface 36 and also to various other components as illustrated. The external packet-data memory is composed of the three RLDRAM devices 13, 14 and 15. Each device may be 36 bits wide and either 8 M or 16 M deep. For each device, 4 bits are reserved for ECC codes. Therefore, 32 bits are available for data. Thus data memory is either 96 MB or 192 MB, depending on the choice of RLDRAM.

Frame data memory may be organized as discrete buffers of 24 KB, with up to either 4096 or 8192 buffers available, depending on the choice of RLDRAM.

Each data buffer is dynamically allocated and de-allocated by the buffer manager (BMGR) 37, under the control of the queuing engines and de-queuing engines.

Frames are written to the external packet-data memory by the queuing engines, into per-port virtual input FIFOs (not shown). The virtual input FIFOs are composed of one or more data buffers.

Frame data is written to the per-port virtual input FIFOs by means of a per-port data buffer. As each per-port buffer is filled, the queuing engines request a new buffer for the port from the BMGR 37. The BMGR maintains a pool of free buffers, and returns a buffer identifier from the top of the free pool. The queuing engines may maintain per port an active buffer into which data is written and a “hot” buffer which becomes the active buffer when the current active buffer is filled.

An ingress traffic management block (ITMB) 38 is provided to manage ingress traffic in accordance with a multiplicity of stored traffic management profiles. Traffic management requests are issued to the ingress traffic management block (ITMB) 38 by the ITQE 27 or the ETQE 33 as the case may be as each frame is received from a client port or a network port respectively. The ingress traffic management block determines whether the frame as represented by various parameters, conforms to a relevant traffic profile and a result is returned to the requesting block 27 or 33, which uses the result to determine whether to queue the frame or not.

A traffic queue congestion avoidance block (TQCA) 39 is coupled to the queuing engines 27 and 33 and processes requests per frame from the queuing engines. It is provided to support the quality of service (QoS) function of allocating buffer resources. Congestion can occur on both ingress and egress, causing queues to lengthen. The scheme for congestion avoidance limits the length of each queue, to allow correct allocation of available buffers among different forwarding classes.

As previously mentioned, connection with a control processor (not shown) is provided by way of a PCI bus 20. This is coupled to an EMBA 40, which supports direct memory access (DMA) to the TQCA 39, a processor channel dequeuing engine (PCDE) and a processor traffic queuing engine (PTQE) 41.

The EMBA 40 has an on-chip bus 42 to all blocks. It also has a DMA interface for receiving data from a statistics block (STAT) 43 which has interfaces with the blocks 25. 27, 30 and 35.

A processor traffic queuing engine PTQE 41 is provided for the insertion of frames under the control of the external processor. For example, for frame insertion by means of DMA, software configures the frame-transfer parameters by way of interface 40 into the PTQE block 41. These parameters include the frame length, external PCI DMA start address, and the forwarding information. Software initiates the frame transfer. The EMBA 40 executes the DMA across the PCI interface 20, and transfers the frame data and prefixed control information into the PTQE 41.

Frames can be extracted from any of the network ports or client ports and forwarded to the control processor (not shown). Frame extraction uses a processor channel de-queuing Engine (PCDE) 44, which is similar to the SCDE 23 and is coupled to the packet-data memory interface 24.

A service configuration RAM block SCRB 45 provides read access for the PFCPs 25 and read and write access for the control processor access to centralized internal service tables. These tables store service parameters used in ingress classification, forwarding lookup and packet processing functions.

Finally, there are two blocks, the MAC processing table block (MPTB) 46 and the network MAC processing table block (NMPT) 47, which are relevant to the lookup which is customarily performed by a switch to determine from (among other things) the destination address in a packet the port from which the packet should be forwarded. Normally as is well known there are other factors which influence the choice of destination and whether the packet will be forwarded.

The MAC processing table block (MPTB) 46 is coupled to the client ports and in particular to the receive (Rx) side of the PFCPs 25. It provides access to the centralized external MAC-table memory in response to packets received by the client ports. Access to the client-side MAC tables may be arbitrated amongst multiple requesters. Each requestor can read from and write to the MAC tables. Access to the tables is also available to the PTQE 41 and the control processor. The NMPT 47 is generally similar to the MPTB 46 but provides access to the MAC tables in the memory 11 and is coupled to the EFPE as the MPTB is coupled to the PFCPs.

### Specific Description

It is now appropriate to describe the manner in which the switch performs lookup, queuing and flooding so that the nature of the disclosed subject matter may be appreciated. As will be understood, the description of the (very complex) operation of the switch is deliberately simplified to omit features which have no real relevance to the disclosed subject matter.

### Service Identification

Modern switches are required to perform emulation of LAN operation (ELAN) emulation of point-to-point operation (ELINE) and therefore need to map between VLANs and service member sets.

The expected format of a VLAN tag comprises a 12-bit VID field; a single-bit field which defines drop eligibility (DE) for S-Tags and a canonical format Indicator (CFI) for C-Tags; and a 3-bit priority code point (PCP) field, also referred to as the PRIO field.

Each frame is classified based on the port configuration and the VLAN-tag contents of a frame. Classification is based on the outermost VLAN-tag position.

### Service Identification and Service Configuration

As each frame is received, the service to which the frame belongs is calculated. Once the service is identified, the service configuration is used to determine how the frame is to be processed and forwarded.

### Service Identification Using VLAN Lookup

The incoming VID, or the default port-based VID PVID, is used to look up the service identifier in the service-identifier table. This table has one entry for each VLAN.

In Table 1 below, and in the subsequent table, those parameters or values which are not relevant to the disclosed subject matter have been removed for the sake of simplicity and conciseness of description.

TABLE 1
VLAN-to-Service Mapping Table (simplified)

| Table Entry | Description |
|---|---|
| SVC_PTR | This field includes the service identifier. This field is used as the |
| | address of the service-configuration table and as the index for |
| | service statistics. |
| VLAN_OP_STATE | These bits configure the operation state of the VLAN. This is |
| | configured as either |
| | Non Operational |
| | Blocked |
| | Blocked but Learning |
| | Forwarding |
| | When a frame is received for a VLAN for which the |
| | VLAN_OP_STATE is Non Operational, the frame is marked for |
| | discard. When a frame is received for a VLAN for which the |
| | VLAN_OP_STATE is Blocked or Blocked but Learning, the |
| | frame may be marked for discard dependant on further |
| | processing via the port and device reserved tables, which may |
| | identify the frame as a control frame. |

Each client port supports an independent VLAN-to-service mapping table.

### Service Configuration

The service pointer shown in Table 1 is used to look up the service-configuration parameters, which are described in Table 2. E-LAN and E-Line services require different parameters. The E-LAN services are restricted to be addressed by the SVC_PTR in a desired range. In this region, each service-configuration entry can be for an E-Line or E-LAN service. The remaining service-configuration entries can be configured only as E-Line services.

TABLE 2
Service-Configuration Parameters (simplified)

| | E-LAN/ | |
|---|---|---|
| Table Entry | E-Line | Description |
| ELAN_MODE - | E-LAN | This bit indicates whether the service is an E-LAN |
| | E-Line | or E-Line service. When this bit is set to 1, the |
| | | service is an E-LAN service. When this bit is set to |
| | | 0, the service is E-Line. E-LAN services may require |
| | | MAC-forwarding functions. E-Line services obtain |
| | | forwarding information directly from the service |
| | | configuration. |
| MC_DEF_PMAP_PTR[12:0] | E-LAN | This field includes a pointer to the default floodmap |
| | | that is used to forward multicast frames, when the |
| | | MAC lookup fails for a multicast frame in this |
| | | service. |
| MC_DEF_PMAP_VALID | E-LAN | This bit indicates whether the |
| | | MC_DEF_PMAP_PTR is valid. When the |
| | | MC_DEF_PMAP_VALID is cleared, the default |
| | | multicast floodmap is the same as the service |
| | | member set. |
| MSTP_IDX[5:0]- | E-LAN | This field includes the Multiple Spanning Tree |
| | | Protocol (MSTP) index for the E-LAN service. This |
| | | field is used to index a portmap table including the |
| | | blocking state for each output port for the MSTP |
| | | instance. |

### Queuing

Frames received in client ports are queued to external packet memory 13, 14, 15 by means of the ingress traffic queuing engine (lTQE) 27. Frames received in network ports are queued to external packet memory by means of the egress traffic queuing engine (ETQE) 33.

There is one ITQE 27 per client port, whereas the EQTE 34 supports all network ports in a time-sliced manner. The functions for both ITQE 27 and ETQE 33 10 are similar, as described in the following sections.

For each frame written to data memory, the respective queuing engine generates a control entry. Frames are queued to the external packet-data memory 13, 14, 15. Control entries are queued to the external packet-control memory 17.

### Control-Entry Generation

For each frame written to data memory, the control entry includes frame data location and frame size, forwarding information and encapsulation information, and drop status based on Quality of Service (QoS) results and frame error status. Frame data pointer fields used to identify the location in data memory of each frame An example of the parameters of a control entry is given below.

The control entry is queued to control memory by the queue controller (QCTL) 35. The queuing engines transfer control entries to the QCTL 35 for each frame when the forwarding information (from the lookup) is available, and (although not relevant to the specific disclosed subject matter) traffic policing has completed and the “color” of the frame is known, CA has completed and the drop requirements are known for each drop eligibility.

The queuing engines can mark a frame for discard based on frame error status resource error status, drop precedence value returned by TM, a drop command returned by CA or filter indicators from forwarding-lookup results. Frame discard can occur, depending on when the discard is detected, either in effect by not queuing the control entry for the frame, or by direct discard before a frame is written to data memory.

### Control-Entry Queue Processing

The QCTL 35 writes control entries to control queues in packet-control memory. The control queues are arranged per forwarding class per destination port.

Each of the following destination ports has eight forwarding classes or queues per port, e.g. eight for each of 128 network ports, 10 client ports and one control processor port. Therefore, the switch in this example provides a total of 1112 control queues. The control queues form the output-port queuing structure.

Each of the 1112 control queues exists as a contiguous FIFO. The head and tail of the FIFO are included in internal memory (not shown). The middle of the FIFO is included in the external packet-control memory 17, which may be composed of a single 32-MB RLDRAM device that is 36 bits wide.

The internal head FIFOs are emptied to packet-control memory. The internal tail FIFOs are filled from packet-control memory. The internal head and tail FIFOs are used to compensate for variable latency in packet-control memory access times, as described in GB patent application No. 0806014.7 and are used to sustain full line rate performance.

The external control queues are formed from a collection of fixed-size buffers in control memory. Buffers are allocated and de-allocated dynamically as control entries are queued and de-queued. Buffers are chained to form per-queue FIFO, by means of an internal linked list. Each queue has a configured maximum depth, which may be configured up to a maximum that can be allocated to a given queue. The depth of each control queue is calculated by the QCTL 35 as each control entry is queued or de-queued. If a control queue fills to its maximum depth, subsequent entries are dropped.

The QCTL 35 uses the control-entry information received from the queuing engines. This information is used to determine how to queue the control entry. Queue identification may be accomplished by means of destination portmap or destination port 10, control processor copy indicator, and forwarding class. A “queue or drop” indicator instructs the QCTL 35 whether the control entry should be discarded or queued.

### Unicast Control-Entry Queuing

For unicast frames with a known address, or multicast frames with a known single destination port, the destination port and forwarding class are uniquely known. Thus, a single control queue is identified to which the control entry is written.

### Multicast and Flooded Frame Queuing

For multicast frames or unknown unicast frames where there are multiple destination ports, the control entry for a frame is written to multiple control queues. The portmap and forwarding class are used to identify the set of control queues to which an entry must written be.

### De-Queuing Frames

Frame de-queuing is also controlled by the queue controller QCTL 35. For this purpose the QCTL 35 reads control entries from control queues in the packet-control memory 17. The QCTL 17 forwards the control-entry parameters to data-frame readers, which de-queue the frame data. There may be separate frame-reader blocks for network ports and client ports.

For each client port, the respective single channel de-queuing engine (SCOE) 23 reads frames from data memory 13, 14, 15. The SCOE 23 passes the frame data, together with the relevant control-entry parameters required to perform transmit-port processing, to the port forwarding and classification processor (PFCP) 25.

For the network ports, the frame reader engine (FROE) 28 reads multiple frames from data memory for multiple network ports. The FROE 28 passes the frame data, together with the relevant control-entry parameters required to perform network-port encapsulation and transmit-port processing, to the ingress frame processing engine (IFPE) 30. The FRDE 28 supports all the network ports concurrently.

Congestion may be managed using queue scheduling. De-queuing of the control queue is scheduled for each destination port. Each network port may be scheduled based on a configurable table which allocates the de-queuing bandwidth proportionally, based on the bandwidth of the network port. Each client port may be scheduled based on a round-robin algorithm that allocates the de-queuing bandwidth equally amongst the ten client ports. The total de-queuing bandwidth may be divided equally between client ports and network ports using simple round-robin between the client ports and the network ports. Each of the eight queues per port may be selected based on the congestion management algorithm.

The QCTL 35 reads control entries, and either processes the control-entry information, or passes the information to the appropriate frame reader. The control-entry information is used by the QCTL for local processing. The control entry information is used to determine how to de-queue the frame data. The frame data pointer fields are used to identify the location in data memory of each frame. A pointer is used to retrieve MPLS-label information for VPLS and VPWS frames. Other information is used to control frame encapsulation information in the IFPE 30 or the PFCP 25.

A configurable table (not shown) read independently and concurrently by the FRDE 28 and by the QCTL 35 may be used to schedule bandwidth for the network ports for the de-queuing of control entries and the de-queuing of frame data. The organization and use of this table is not strictly relevant to the disclosed subject matter.

### VPLS Replication

As control entries are read by the QCTL 35 certain parameters determine when VPLS replication is required. This will not be described in detail because it has already been described in the aforementioned patent applications.

### VPLS and VPWS Label Processing

Two tables may be used to process VPLS and VPWS labels, e.g., a table for unicast frames and a table for multicast frames. For each PW, the label information in each table may be the same. However, the organization of the two tables allows the FRDE 28 to fetch the required labels for frames in an efficient manner. These label tables are stored in the external label memory 17. Again, this need not be described in detail herein.

### Unicast Table Structure

The unicast table (not shown) is a simple table that stores as many PWs as are required.

The FRDE 28 accesses the table using an index value (PW_IDX) and a configurable offset to calculate the address of the label entry. Software configures the unicast-label table by means of indirect access. Only a single copy of the unicast table is required, because individual labels can be added or removed without impacting the data-path operation.

### Multicast Table Structure

A multicast table (not shown) is organized so that the FRDE 28 can simply process all labels associated with a VPLS multicast group and VPLS Instance for a given network port. Each frame that is to be multicast can be required to be forwarded to multiple PWs being carried over multiple network ports. The QCTL 35 and FRDE 28 can process frames for different network ports concurrently. Therefore, for each network port, the table includes all of the PW entries, in one embodiment, grouped by VPLS Instance and VPLS multicast group per port. Table 3 below indicates the parameters for the pseudo-wire table

### Unicast Frames

When a frame has a single destination port and a single destination PW, the control entry includes a pointer to a label entry in a unicast-label table. The label-table parameters are used by the FRDE or the IFPE to validate the requested VLAN and to use only valid labels for encapsulation.

The IFPE uses the valid MPLS labels, requested VLAN and other relevant parameters to encapsulate the frame.

### Multicast and Flooded

When a frame has multiple destination PWs on a single port or multiple ports, the QCTL 35 provides the root address of the first label of the forwarding group. A link field is used to locate the next four labels in the chain. The current identification of the source PW is used to filter the frame e.g., to provide same PW discard.

### MAC-DA Lookup

The destination MAC address OA, together with the an identification of a filter information database (FID) returned from the service-configuration lookup, is used as the input to the lookup function. The MAC lookup tables support the following switching from any port to any port across client ports, network ports, and the control processor port FIDs or virtual MAC tables.

The following Table 3 indicates by way of example the relevant parameters in 10 the MAC tables.

TABLE 3
Relevant MAC-Table Parameters

| | Unicast (UC) | |
|---|---|---|
| | or Multicast | |
| Table Entry | (MC) | Description |
| DEST_PID[7:0) | UC | This field is the destination port identifier. Ports |
| | | 0 to 127 are network ports. Ports 128 to 137 are |
| | | client ports. |
| DEST_PID_VAL | UC | When this bit is set to 1, the DEST_PID field is |
| | | valid. |
| FID[10:0] | UC | This field is the actual FID for the entry. This |
| | MC | field is used, together with the MAC_ADDR and |
| | | VALID fields, by the forwarding-lookup |
| | | processor to determine when a MAC-table hit has |
| | | occurred. |
| FWD_TYPE | UC | This bit indicates whether frames with the |
| | MC | destination matching the MAC address and FID |
| | | should be filtered or forwarded, as follows: |
| | | When this bit is set to 1, forward the frames. |
| | | When this bit is set to 0, filter the frames. |
| MAC_ADDR[47:0] | UC | This field is the actual DA or SA for the entry. |
| | MC | This field is used, together with the FID and |
| | | VALID fields, by the forwarding-lookup |
| | | processor to determine when a MAC-table hit has |
| | | occurred. |
| MC_PMAP_PTR[13:0] | MC | This field includes a pointer to the multicast |
| | | portmap table. |
| MC_PMAP_VAL | MC | This bit indicates whether the MC_PMAP_PTR |
| | | is valid. When this bit is set to 1, |
| | | MC_PMAP_PTR includes the destination |
| | | portmap pointer. When this bit is set to 0, |
| | | SVC_PTR includes the destination portmap |
| | | pointer, and the multicast floodmap for the MAC |
| | | address is the same as the service member set. |

### Forwarding-Lookup Processing

A forwarding-lookup MAC-OA is performed using hashing of the MAC 15 address and FID to generate a MAC-table address, the linking of entries and the comparison of the results (MAC table entries) with the input MAC address and FID. For unicast frames for which the DA search is successful for the given FID, the MAC-DA lookup provides a result which includes an identification of the destination specifies whether the port is a network port, client port or CP port. The frame is marked to be forwarded or discarded. For multicast frames for which the DA search is successful for the given FID, the MAC-DA lookup provides a set of values which specify a pointer to the set of destination ports and directly specify whether the CP port is included. The frame is marked to be forwarded or discarded.

For unicast or multicast frames for which the DA is unknown or the search is unsuccessful, the MAC-forwarding process generates a search-fail indicator, including the reason for the search fail. The MAC-table search may fail for any of several reasons. The address may be unknown. The MAC forwarding-lookup may have been stopped because the hash chain was long, which caused the forwarding-lookup FIFO to reach critical thresholds.

If the MAC-table search fails, the frame is normally “flooded”, in dependence on the frame type. For multicast frames, the frame is flooded to the default multicast floodmap. The default multicast floodmap is identified to QCTL based on the values of the control entry interface parameters. For unicast frames, the frame is flooded to the service member set floodmap. Optionally, if a MAC-table search fails, the frame may be discarded or forwarded to the control processor.

### VPLS Services

For VPLS services, the same MAC structures are used as for PB. However, additional MAC-table fields are used as follows. For unicast frames for which the DA search is successful for the given FID and for destination network ports only, the MAC-DA lookup provides the PW identifier PW_IDX and a validity field. The PW_IDX is only used when the validity field is set to 1 and the PW_SVC bit from the service configuration table is set to 1. Otherwise, the PW_IDX is ignored.

For multicast frames for which the DA search is successful for the given FID, the MAC-DA lookup provides a VPLS_MCG identifier. The VPLS_MCG identifier is used together with the FID_VPLSI and the destination ports, to identify the PWs over which the frame is to be forwarded.

For unicast or multicast frames for which the DA is unknown or the search is unsuccessful, the frame is flooded depending on frame type as follows.

For multicast frames, an appropriate identifier is used together with default multicast floodmap, to identify the PWs over which the frame is to be forwarded.

For unicast frames, the appropriate identifier is used together with the service member set, to identify the PWs over which the frame is to be forwarded.

### Frame Forwarding-Result Processing

Each received frame undergoes multiple lookup processes to determine whether to forward or filter and how and where to forward the frame. The results of these lookup processes are used to generate the final forwarding-information result. Processing of the forwarding-result accumulates and combines results from a multiplicity of processes. Typically these processes include a service-configuration lookup, a MAC-DA lookup, a port-reserved-table lookup, a device-reserved-table lookup, tag filtering and VLAN Filtering.

The forwarding and filtering of a frame depends on the status prioritization from the various lookup processes. Typically, the result from the port-reserved table has the highest priority. The result from the device-reserved table has the second-highest priority. When there is no reserved-table-address match, the tag-filter, VLAN-filter, and service-filter results are used to determine whether a frame is to be discarded or not.

Depending on the service type, a forwarding-result is generated as follows. An E-Line forwarding-result is taken from the service-configuration table. An E-LAN forwarding-result is taken from one of two sources. If there is a MAC-table hit, the forwarding-result is taken from the MAC-forwarding process. If there is not a MAC-table hit, the forwarding-result is taken from the service-configuration table.

Thus, frames that match reserved addresses can be forwarded to the CP port 20, regardless of the result of tag filtering or VLAN filtering. For example, untagged Spanning Tree Protocol (STP) Bridge Protocol Data Units (BPDUs) can be forwarded to the CP.

The forwarding process generates a set of parameters for each frame, which are used as a control entry for the frame. These parameters and their usage are generally described in the aforementioned European patent application. Each of these parameters, as well as buffer-memory address information, is passed to the QCTL 35, which formats and queues the control entry to external memory. Table 4 below indicates the set of control entry parameters for forwarding and encapsulation.

TABLE 4
Relevant Control-Entry Parameters

| | | | Relevant |
|---|---|---|---|
| Parameter | Description | Source | Modes |
| ELAN_MODE | When this bit is set to 1, the current | SCR | All |
| | frame is for an E-LAN service. | | |
| | When this bit is set to 0, the frame is | | |
| | for an E-Line service and all portmap | | |
| | tables are ignored. | | |
| FLEN | This field includes the frame length | Generated | All |
| | in bytes. | | |
| MC_PMAP_PTR | This field includes the multicast | Generated | All |
| | portmap pointer. When SP_FLAG is | from MAC | |
| | set to 0, this field includes a pointer | Table or SCR | |
| | to the from MAC | | |
| | multicast portmap table. The | | |
| | multicast portmap table is used to | | |
| | identify the destination ports for a | | |
| | multicast frame. This table supports | | |
| | unknown multicast address portmaps | | |
| | as well as known multicast address | | |
| | portmaps. When SP_FLAG is set to | | |
| | 1, this field includes a destination | | |
| | PID in the lower bits. | | |
| MC_PMAP_VAL | This bit indicates that the | Generated | All |
| | MC_PMAP_PTR is valid and should | from MAC | |
| | be used for locating a multicast | Table or SCR | |
| | portmap. | | |
| | When this bit is set to 0, the | | |
| | SVC_PMAP_PTR includes a pointer | | |
| | to the multicast portmap. | | |
| | This bit does not validate | | |
| | MC_PMAP_PTR when SP_FLAG is | | |
| | set to 1. | | |
| MSTP_IDX | This field is used to index into the | SCR | All |
| | MSTP portmap table used to process | | |
| | output-port blocking. | | |
| SP_FLAG | This single-port flag is generated by | Generated | All |
| | the forwarding process to indicate | | |
| | that there is a single destination that | | |
| | is overlaid onto the MC_PMAP_PTR | | |
| | parameter. | | |
| SRC_PID | This field includes the source port | Generated | All |
| | identifier. | | |
| SRC_PW_IDX | This field includes the source PW | Egress PW | VPxS |
| | index, which indicates the PW from | Table | |
| | which the frame was received. This | | |
| | field can be used to ensure that a | | |
| | frame is not forwarded to the same | | |
| | PW from which the frame was | | |
| | received. | | |
| SVC_PMAP_PTR | This field includes a pointer to the | VIDto SVC | All |
| | service member set portmap table. | Table | |
| | This field is identical to the | | |
| | SVC_PTR but is valid for E-LAN | | |
| | services only | | |

### MAC-Address Learning and Aging Support

MAC learning support provides software with the required parameters to update MAC tables for various circumstances. These are basically: (a) an unknown SA received, e.g., the SA/FID pair is not in the tables; (b) a known SA address on different port, e.g., the SA/FID pair is in the table but was previously learned on a different port; (c) a known SA address on different PW, e.g., the SA/FID pair is in the table but was previously learned on a different PW; or (d) a known SA address from a different BEB, e.g., the SA/FID pair is in the table but was previously learned against a different provider backbone station address B-SA.

In these cases, the following information is provided to software: a PID indicating the port for which the learning event is valid; the SA; the FID; the result from the SA/FID hash; a learning event reason; a source PW identifier, the PBB source station address B-SA.

Learning-event registers are maintained for each client port. A single learning-event register is maintained for the network ports. A maskable interrupt is generated for each learning event. New learning events for each learning-event register are lost, if software has not read the previously registered learning-event register.

As each frame is received and the MAC learning process runs, the MAC-SA lookups provide support for the aging process. For every successful dynamic SA search, where the SA is found in the table and the entry is dynamic, the MAC entry is refreshed in hardware to prevent aging out of the entry by software. The refresh is done by writing a “touched” bit back with a “1”. The entry is not refreshed by the hardware if (a) a source learning search identifies the address as being a static entry; or (b) a known SA is found but on a different port; or (c) a known SA is found but on a different PW; or (b) a known SA is found but from a different PBB edge bridge, B-SA.

### Port States

Spanning Tree Protocol (STP) defines different port states for which specific hardware and software support may be required. The STP port states are described 20 in Table 5 below.

TABLE 5
STP Port States

| Port State | Description |
|---|---|
| Blocking | The port does not forward any frames received, and does not |
| | forward frames received from the relay: that is, input-port |
| | blocking and output-port blocking. |
| Listening | The port does not forward any frames received, and does not |
| | forward frames received from the relay. |
| Learning | The port does not forward any frames received, and does not |
| | forward frames received from the relay: that is, input-port |
| | blocking and output-port blocking. In the Learning state, SA- |
| | learning is enabled. |
| Forwarding | The port forwards frames received, and forwards frames received |
| | from the relay. In the Forwarding state, SA-learning is enabled. |
| Disabled | No frames are received or transmitted. |

### Multiple Spanning Tree Blocking Table

Each service is mapped to a Multiple Spanning Tree Instance (MSTI) in the service-configuration table. The MSTP_IDX parameter specifies one of 64 MSTls for each E-LAN service. The MSTP_IDX is used as an index into a Multiple Spanning Tree portmap table. The table includes the blocking state of each port for that MSTI. Blocked ports are excluded from the forwarding portmap. In the known unicast case where a single destination port is identified for a frame, and the destination port is blocked, the frame can be either discarded or flooded.

### Summary of General Operation

The foregoing is lengthy and for the purposes of the present disclosed subject matter may be summarized as follows.

The block EMBA 40 is the interface with the control processor. It holds overall configuration and status registers. It supports the transmission (by way of bus 42) of configuration and status data to all the other blocks as required. Each block may have its own local control and status registers.

The blocks PFCP 25, EFPE 34, MPTB 46 and NMPT 47 are the blocks involved with lookup. The blocks PFCP 25 and EFPE 34 perform the bulk of the lookup algorithm, whereas MPTB 46 and NMPT 47 perform the table reads under the control of PFCP 25 and EFPE 34.

A service member set, e.g. an emulated LAN, is defined by a respective port bitmap accessed from the relevant parameter in the service configuration table.

### Service Member Set Flooding

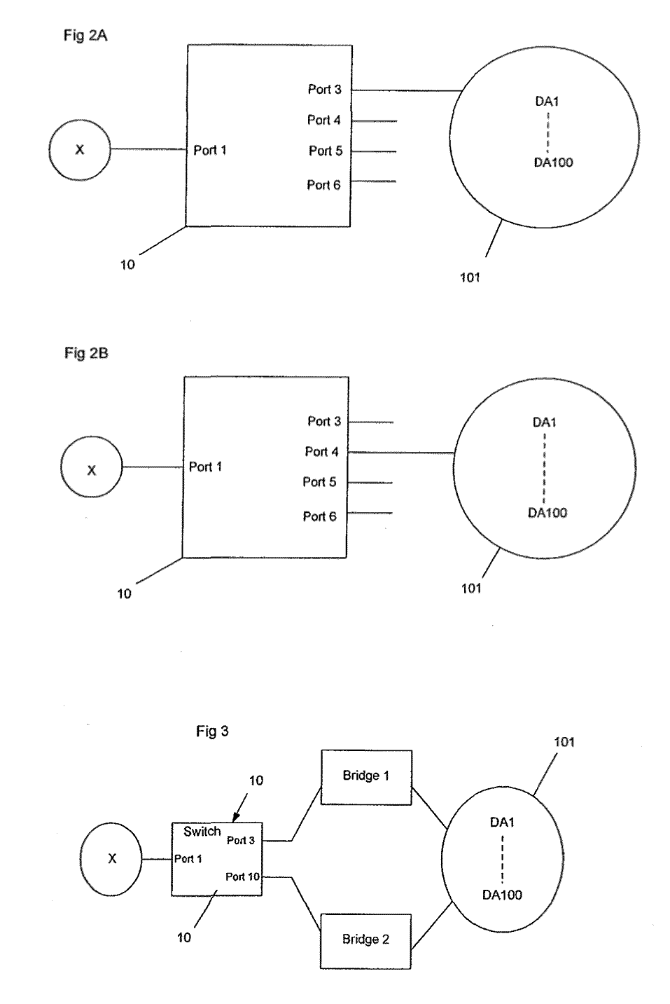

As noted earlier, one of the particular significances of the present disclosed subject matter is the fast emulation of MAC table flushing One example of this process will now be explained with reference to FIGS. 2A and 2B.

In FIG. 2A is shown in simplified form the switch 10, in which an ELAN service has been set up with ports 1, 3, 4, 5 and 6. The service member set is defined by way of a portmap table in the QCTL. This table includes one portmap for each E-LAN service. The portmap includes a bit for each port (128 network ports and 10 client ports in this example) and for each port that is a member of the respective service the associated portmap bit is set; for the other ports the associate bit is “clear”. The circle X represents a source of packets. The circle 101 represents a multiplicity of destination addresses, DA 1 to DA 100 (inclusive) which are all associated in the switch 10 with port 3. That is to say, they have been learned for that port and all appear in the relevant MAC table.

Now let the destination addresses associated with port 3 be moved to port 4 and port 3 be removed from the service member set. This may be due to a reconfiguration of an adjoined network. For example, DA 1 to DA 100 might not be connected directly to port 3 but may be connected via a switched network running STP. The new configuration is shown in FIG. 2B.

Suppose now that a unicast packet arrives from the source X, and has a MAC destination address DA 1. There is a lookup for this address. The result is a “known” ELAN unicast with a destination port identification (dest_pid) identifying port 3. The QCTL 35 determines that port 3 is not part of the service member set. This is done by detecting that the associated bit in the service member set table for port 3 is cleared.

There are now two alternatives. One is the discard of the packet. The other is the initiating of MAC address flooding of DA1 to all ports in the service member set.

Preferably these actions are configurable e.g., selectively enabled for each service member set.

The flooding is controlled by the QCTL, which has recourse to the port bitmap for the respective service set to determine the destination ports.

Port 1 is excluded from the flooding by virtue of the “same port discard” rule, so the packet is forwarded from the permitted ports 4, 5 and 6 and arrives via port 4 at its destination. There will be a reply from the address DA 1 (e.g., a reply packet with a source address=DA 1). This causes a source port mismatch in the switch and (in accordance with known practice) initiates a learning event to update the MAC entry to dest_pid 4.

The source will continue to send in packets for the destinations DA 1 to DA 100 and the updating will continue until all the destinations are learned for port 4. If the service member set flooding were not employed, the switch would have to wait for the addresses to age out gradually from the MAC table for port 3; the MAC lookup would then flood. In between times the packets would be sent to port 3 with loss of connectivity. If X is sending to DA 1 etc. the refresh of MAC tables is for the SA of X not the DA 1 to DA 100.

The advantage of the check for a known unicast destination port against the service member set and the consequent flooding in the event of a “failure” of that check is that otherwise the packet would not reach its intended destination.

### Spanning Tree Flooding

Another example of the use of service member set flooding is represented by FIG. 3. In this Figure, the switch 10 has port 1 coupled to a source X of packets. An ELAN service has been set up with ports 1, 3 and 10. Port 3 is connected to destinations DA 1 to DA 100 via bridge 1. Bridge 2 potentially connects the switch to destinations DA 1 to DA 100 but port 3 is unblocked and port 10 is blocked by the operation of STP.

Now suppose bridge 1 breaks. The spanning tree protocol will unblock port 10 and block port 3. STP will block ports in two places. Receive (Rx) ports are blocked in the receive forwarder blocks PFCP and EFPE. The VLAN_ OP STATE is configured to do this. Each VLAN on a port may have a different STP state. Transmit (Tx) ports are blocked in QCTL. Each E-LAN service has an associated multiple spanning tree instance (MSTI_IDX). This defines which ports are blocked and which are unblocked, by means of a portmap table in QCTL. The instance MSTI_IDX addresses the table, which includes one bit per port (138 in this example) and this portmap is ANDed with the portmap which defines which ports are in the destination port set. By setting and clearing bits in the MSTI portmap table ports are set to the respective required blocked and unblocked states.

Suppose now a unicast packet arrives from the source X, and has a MAC destination address DA 1. There is a lookup for this address. The result is a “known” ELAN unicast with a destination port identification (dest_pid) identifying port 3. The QCTL 35 determines with reference to the respective port bit map that port 3 is blocked. There is now a MAC address flooding of DA 1 to all permitted ports in the service member set. Port 1 is excluded from the flooding by virtue of the “same port discard” rule. Port 3 is blocked by the spanning tree, so the packet is forwarded from port 10 and arrives via bridge 2 at its destination. There will be a reply from the address DA1 (e.g., a reply packet with a source address=DA1). This causes a source port mismatch in the switch and initiates a learning event to update the MAC entry to dest_pid 10.

The source X will continue to send in packets for the destinations DA 1 to DA 100 and the updating will continue until all the destinations DA 1 to DA 100 are learned for port 10.

If the spanning tree flooding were not employed, the switch would have to wait for the addresses to age out gradually from the MAC table for port 3; the MAC lookup would then flood.

Implementations of the various techniques described herein may be implemented in digital electronic circuitry, or in computer hardware, firmware, software, or in combinations of them. Implementations may be implemented as a computer program product, e.g., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Components may be interconnected by any form or medium of digital data communication, e.g., a communication network. Examples of communication networks include a wireless network, local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. An apparatus including:
a plurality of ports configured to receive and forward packets within a communications network;
a port forwarding processor configured to determine a destination port associated with a received packet; and
a queue controller configured to:
define at least one emulated local area network (ELAN) via a respective service member set that identifies which ports are members of the service member set,
determine whether or not the destination port is a permitted member of the service member set, and
if the destination port associated with the received packet is not a permitted member of the service member set, flood the received packet to the permitted members of the service member set.

2. The apparatus of claim 1, wherein the queue controller is configured to transfer connectivity of destinations associated with a bad port to at least one other port in the service member set such that the port ceases to be a permitted member of the set.

3. The apparatus of claim 1, wherein the apparatus is configured to block a bad port in response to the operation of a spanning tree protocol, such that the bad port ceases to be a permitted member of the service member set.

4. The apparatus of claim 1, wherein the apparatus is configured to store payloads of packets while processing and queuing separately from payloads control entries that define the packets.

5. The apparatus of claim 4, wherein the apparatus includes a port bitmap configured to indicate which ports are permitted members of the service member set.

6. The apparatus of claim 1, wherein the apparatus includes a port bitmap configured to indicate which ports are permitted members of the service member set; and
wherein the apparatus is configured to modify the port bitmap to cause a port to cease to be a permitted member of the service member set.

7. The apparatus of claim 1, wherein the apparatus is configured to, in response to flooding the received packet to the permitted members of the service member set, receive a reply, which causes a destination port mismatch, from a destination address associated with the received packet, and
update the destination port associated with the received packet.

8. A method of transmitting data via a networking apparatus including:
receiving and transmitting, via a plurality of ports, packets within a communications network;
determining a destination port associated with a received packet;
defining at least one emulated local area network (ELAN) via a respective service member set that identifies which ports are members of the service member set;
determining whether or not the destination port is a permitted member of the service member set; and
if the destination port associated with the received packet is not a permitted member of the service member set, flooding the received packet to the permitted members of the service member set.

9. The method of claim 8, further including transferring connectivity of destinations associated with a bad port to at least one other port in the service member set such that the port ceases to be a permitted member of the set.

10. The method of claim 8, further including blocking a bad port in response to the operation of a spanning tree protocol, such that the bad port ceases to be a permitted member of the service member set.

11. The method of claim 8, further including storing payloads of packets while processing and queuing separately from payloads control entries that define the packets.

12. The method of claim 8, wherein determining whether or not the destination port is a permitted member of the service member set include utilizing a port bitmap configured to indicate which ports are permitted members of the service member set.

13. The method of claim 8, wherein modifying a port bitmap to cause a port to cease to be a permitted member of the service member set, and
wherein the port bitmap port bitmap indicates which ports are permitted members of the service member set.

14. The method of claim 8, further including receiving a reply, in response to flooding the received packet to the permitted members of the service member set,
wherein the reply causes a destination port mismatch, from a destination address associated with the received packet; and
updating the destination port associated with the received packet.

15. A computer program product for transmitting information, the computer program product being tangibly embodied on a computer-readable medium and including executable code that, when executed, is configured to cause a networking apparatus to:
receive and transmit, via a plurality of ports, packets within a communications network;
determine a destination port associated with a received packet;
define at least one emulated local area network (ELAN) via a respective service member set that identifies which ports are members of the service member set;
determine whether or not the destination port is a permitted member of the service member set; and
if the destination port associated with the received packet is not a permitted member of the service member set, flood the received packet to the permitted members of the service member set.

16. The computer program product of claim 15, wherein the executable code that, when executed, is configured to cause the networking apparatus to transfer connectivity of destinations associated with a bad port to at least one other port in the service member set such that the port ceases to be a permitted member of the set.

17. The computer program product of claim 15, wherein the executable code that, when executed, is configured to cause the networking apparatus to block a bad port in response to the operation of a spanning tree protocol, such that the bad port ceases to be a permitted member of the service member set.

18. The computer program product of claim 15, wherein the executable code that, when executed, is configured to cause the networking apparatus to store payloads of packets while processing and queuing separately from payloads control entries that define the packets.

19. The computer program product of claim 15, wherein determining whether or not the destination port is a permitted member of the service member set include utilizing a port bitmap configured to indicate which ports are permitted members of the service member set.

20. The computer program product of claim 15, wherein the executable code that, when executed, is configured to cause the networking apparatus to modify a port bitmap to cause a port to cease to be a permitted member of the service member set, and
wherein the port bitmap port bitmap indicates which ports are permitted members of the service member set.
